(19) United States
(12) Patent Application Publication
(10) Pub. No.: US 2010/0219021 A1
(43) Pub. Date: Sep. 2, 2010

(54) WHEEL BEARING HUB WITH OIL PRESSURE CUP

(76) Inventors: Yongfu WU, Haining (CN); Axin FU, Haining (CN); Minjun WANG, Haining (CN); Yongbo GUO, Haining (CN)

Correspondence Address: MATTHIAS SCHOLL, 14781 MEMORIAL DRIVE, SUITE 1319, HOUSTON, TX, 77079, US

(21) Appl. No.: 12/711,296

(22) Filed: Feb. 24, 2010

(30) Foreign Application Priority Data
Feb. 27, 2009 (CN) 200910096000.5

(51) Int. Cl. F16N 11/10

(52) U.S. Cl. 184/89

(57) ABSTRACT

A hub having an outer ring, an inner ring, a roller, a cage, a filling hole for filling oil, and an oil pressure cap, the filling hole for filling oil being disposed at a sidewall of the outer ring and connected with the oil pressure cap. The hub with an oil pressure cap can be filled with oil periodically and thereby it has good lubrication effect and long service life.

### CROSS-REFERENCE TO RELATED APPLICATIONS

Pursuant to 35 U.S.C. §119 and the Paris Convention Treaty, this application claims priority benefits to Chinese Patent Application No. 200910096000.5 filed on Feb. 27, 2009, the contents of which are incorporated herein by reference.

### BACKGROUND OF THE INVENTION

1. Field of the Invention

The invention relates to a wheel bearing hub of a car, and more particularly to a wheel bearing hub with an oil pressure cap.

2. Description of the Related Art

Conventional wheel bearing hubs are disposable, and during their service lifetime, no maintenance is generally required. However, due to the spatial limitation of the hub, excess oil produces frictional heat, while insufficient oil shortens the service lifetime.

### SUMMARY OF THE INVENTION

In view of the above-described problems, it is one objective of the invention to provide a hub in which oil can be filled periodically so as to achieve good lubrication effect and extend service lifetime.

To achieve the above objectives, in accordance with one embodiment of the invention, provided is a hub comprising an outer ring, an inner ring, a roller, a cage, a filling hole for filling oil, and an oil pressure cap, wherein the filling hole for filling oil is disposed at a sidewall of the outer ring and connected with the oil pressure cap.

Advantages of the invention are summarized below: by disposing the filling hole for filling oil at a sidewall of the outer ring of the hub, the hub can be lubricated periodically as needed, and thereby the service life thereof is extended.

### BRIEF DESCRIPTION OF THE DRAWINGS

The invention is described hereinbelow with reference to accompanying drawings, in which:

FIG. 1 is a schematic diagram of a hub with an oil pressure cap according to one embodiment of the invention; and

FIG. 2 is a sectional view taken from line A-A of FIG. 1 according to one embodiment of the invention.

### DETAILED DESCRIPTION OF THE EMBODIMENTS

For further illustrating the invention, embodiments detailing a hub with an oil pressure cap are described below. It should be noted that the following examples are intended to describe and not to limit the invention.

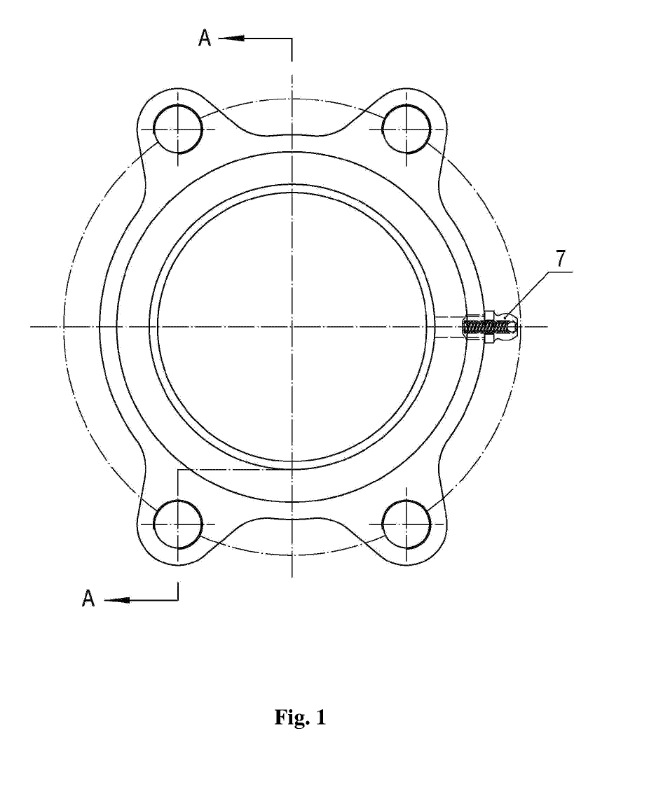

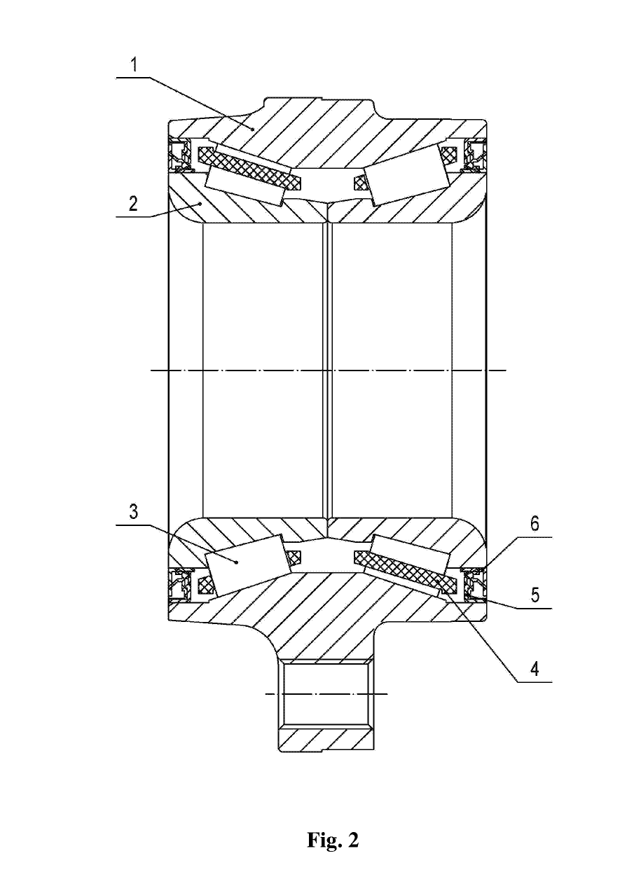

As shown in FIGS. 1 and 2, a hub comprises an outer ring 1, two inner rings 2, a plurality of rollers 3, two cages 4, a threaded filling hole for filling oil, and an oil pressure cap 7, the threaded filling hole for filling oil being disposed at a sidewall of the outer ring 1 and connected with the oil pressure cap 7. The oil pressure cap 7 is in manner of straight-through. So as to form a sealing system, a sealing element 5 and a pressure-resistant cover 6 are disposed in the hub so that the hub is free of dust and the oil cannot leak out.

Specifically, upon installation, 48 rollers 3 are disposed in two cages 4 respectively. The cages are put into the inner rings 2, oil filled, the sealing element 5 and the pressure-resistant cover 6 disposed, and thereby a sealing system is obtained. Subsequently, the oil pressure cap 7 is screwed, anti-rust oil smeared, and the resultant hub is packed for use.

In use, the hub of the invention is combined with a mandrel and fixed with a nut. The outer ring 1 is fixed with a bolt to a suspension shaft of a chassis, a brake disc disposed, and a plurality of rims is fixed with bolts to the mandrel.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A hub comprising
a) an outer ring,
b) an inner ring,
c) a roller,
d) a cage,
e) a filling hole for filling oil, and
f) an oil pressure cap,
wherein
said filling hole for filling oil is disposed at a sidewall of said outer ring and connected with said oil pressure cap.

2. The hub of claim 1, further comprising a sealing element and a pressure-resistant cover so as to form a sealing system.

3. The hub of claim 1, wherein said oil pressure cap is in manner of straight-through.
